(19) United States
(12) Patent Application Publication
(10) Pub. No.: US 2025/0187960 A1
(43) Pub. Date: Jun. 12, 2025

(54) Self-Blending Pressurized Modular Nitrate Reduction System

(71) Applicant: ATEC Water Systems, LLC, Los Angeles, CA (US)

(72) Inventor: Lee Odell, Vancouver, WA (US)

(21) Appl. No.: 18/534,423

(22) Filed: Dec. 8, 2023

(51) Int. Cl. C02F 3/30; C02F 1/00; C02F 3/00; C02F 3/34; C02F 101/16; C02F 103/06

(52) U.S. Cl. CPC C02F 3/306; C02F 1/004; C02F 3/006; C02F 3/34; C02F 2101/163; C02F 2103/06; C02F 2203/006; C02F 2209/005; C02F 2209/15; C02F 2301/046; C02F 2303/16; C02F 2305/06

(57) ABSTRACT

A water treatment system receives nitrate-rich water at pressure from a source and filters that water through an upflow configured biological reactor. Upflow configuration fluidizes a bacterial population within the reactor without requiring mechanical agitation. Outflow of the biological reactor is provided as input to a recirculation loop that at least partially recirculates water back into the reactor, thereby self-blending with influent water provided as inflow to the reactor. The recirculation loop also serves as a dosing location for controlling pH, external carbon availability, and the like. Dosing within the recirculation loop ensures that the environment within the reaction volume remains stable and additives are efficiently perfused. Outflow of the recirculation loop is provided as inflow to downflow configured post filters. Outflow of the post filters can be provided as potable or non-potable denitrified water.

### TECHNICAL FIELD

Embodiments described herein relate to water filtration systems and, in particular, to systems for removing nitrate from a water source.

### BACKGROUND

Nitrate contamination in drinking water poses health risks, including hypoxemia disorders, low birth weight, and potential links to certain cancers. Conventional systems for nitrate level mitigation include removal or reduction systems but both are often large, expensive, and require significant power and ongoing maintenance. Further, many conventional systems exhibit low water recovery efficiency.

Moreover, many conventional systems produce a byproduct of concentrated brine that in many jurisdictions must be handled and disposed of in a regulated manner, further increasing cost and complexity. Blending is an alternative conventional approach in which nitrate-rich water is mixed with uncontaminated water to lower overall nitrate concentration. Necessarily, however, blending requires availability of uncontaminated water and thus is not appropriate or possible at all sites.

### SUMMARY

Embodiments described herein take the form of a water treatment system for denitrification of groundwater. The system includes an inlet coupled to a groundwater source and an upflow configured reaction volume. The volume is defined by an upper portion and a lower portion, the lower portion coupled to the inlet to support upflow within the volume. Within the volume is provided a population of heterotrophic bacteria.

Outflow of the volume is coupled to a recirculation and dosing loop that is configured to recirculate at least a portion of outflow of the reaction volume back into the reaction volume. The recirculation and dosing loop includes an electronically-controllable additive doser configured to dose water within the loop with a carbon source, such as acetic acid.

A portion of outflow of the loop is provided as inflow to a post filter configured for downflow. The post filter includes a volume of filter media configured to arrest any heterotrophic bacteria of the population of heterotrophic bacteria that traverses the loop and enters the post filter. Outflow of the post filter can be provided as denitrified water output, for potable or non-potable purposes.

Additional embodiments described herein take the form of a water treatment system for denitrification of groundwater including an inlet coupled to a pressurized water source, a reaction volume with a population of denitrifying bacteria, and a recirculation loop coupled to configured to recirculate a quantity of outflow of the reaction volume back into reaction volume, the recirculation loop including an additive doser configured to dose water within the recirculation loop with an additive, and a post filter group with at least two post filters each of which is configured for downflow and includes respective filter media configured to arrest particles that enter that respective post filter. Outflow of the post filter group can be provided as a potable or non-potable denitrified water output.

Further embodiments described herein take the form of a method of denitrifying groundwater, the method including operations of: receiving pressurized groundwater from a groundwater source; providing the pressurized groundwater to a reaction volume so as to facilitate upflow within the reaction volume, the reaction volume including a population of denitrifying bacteria; recirculating at least a portion of pressurized outflow of the reaction volume to a recirculation and dosing loop; dosing water within the recirculation and dosing loop with at least one additive to support the population of denitrifying bacteria; filtering pressurized outflow of the recirculation and dosing loop through a group of particle filters, each particle filter with a filter media and configured for downflow operation; and providing pressurized outflow of the group of particle filters as potable water output.

### BRIEF DESCRIPTION OF THE DRAWINGS

Reference will now be made to representative embodiments illustrated in the accompanying figures. It should be understood that the following descriptions are not intended to limit this disclosure to one included embodiment. To the contrary, the disclosure provided herein is intended to cover alternatives, modifications, and equivalents as may be included within the spirit and scope of the described embodiments, and as defined by the appended claims.

FIG. 1 depicts a system diagram of a modular denitrification system as described herein.

FIG. 2 depicts a simplified schematic diagram of a pressurized denitrification system as described herein.

FIG. 3 depicts a simplified schematic diagram of a pressurized modular denitrification system as described herein.

FIG. 4 depicts a flow chart corresponding to example operations of a method of denitrification, as described herein.

FIG. 5 depicts a flow chart corresponding to example operations of a method of backwashing, as described herein.

The use of the same or similar reference numerals in different figures indicates similar, related, or identical items.

The use of cross-hatching or shading in the accompanying figures is generally provided to clarify the boundaries between adjacent elements and also to facilitate legibility of the figures. Accordingly, neither the presence nor the absence of cross-hatching or shading conveys or indicates any preference or requirement for particular materials, material properties, element proportions, element dimensions, commonalities of similarly illustrated elements, or any other characteristic, attribute, or property for any element illustrated in the accompanying figures.

Additionally, it should be understood that the proportions and dimensions (either relative or absolute) of the various features and elements (and collections and groupings thereof) and the boundaries, separations, and positional relationships presented therebetween, are provided in the accompanying figures merely to facilitate an understanding of the various embodiments described herein and, accordingly, may not necessarily be presented or illustrated to scale, and are not intended to indicate any preference or requirement for an illustrated embodiment to the exclusion of embodiments described with reference thereto.

### DETAILED DESCRIPTION

Embodiments described herein relate to water decontamination systems and, in particular, to denitrification systems. Systems and constructions described herein can be leveraged to denitrify groundwater or other nitrate-rich water sources.

As known to a person of skill in the art, certain water sources may be nitrate-rich. Nitrate is an acute inorganic contaminant to potable water. In addition to potentially imparting an unpleasant odor and/or color to water, consumed nitrate is easily converted to nitrite in the body which can contribute to hypoxemia disorders, low birth weight, and other medical concerns. Further, some research suggests a link between long-term nitrate consumption and certain cancers. Maximum contamination levels (MCLs) for both nitrate and nitrite are set by the U.S. Environmental Protection Agency (EPA) and other similar regulatory bodies worldwide. If a particular water source exceeds nitrate or nitrite MCLs, nitrate mitigation is likely required.

Generally and broadly, nitrate levels have been conventionally reduced in three ways: (1) blending, (2) nitrate removal (also referred to as “water recovery” techniques), (3) or nitrate reduction. Blending is a conventional technique for reducing nitrate concentration in which a high nitrate concentration water source is combined, in suitable proportion, with a low nitrate water source in order to dilute overall nitrate concentration below EPA standard MCL. Blending is not suitable for treating many water sources, however, as low-nitrate water is expressly required as an input (whether sourced locally or transported in). Further, blending systems often require dedicated storage, plumbing, and/or pumping systems that introduce additional mechanical and operational complexities and expenses. Blending has significant downsides and is neither a cost-effective nor available option for denitrification in many areas. Further, many view blending as a sub-optimal use of low-nitrate water.

Other conventional solutions for nitrate mitigation that do not require blending can be categorized as nitrate removal systems or nitrate reduction systems. Broadly, nitrate removal systems are designed to extract water from nitrate-rich sources whereas nitrate reduction systems are designed to destroy nitrate in situ and/or convert dissolved nitrate to another substance (such as nitrogen gas).

A significant downside of conventional nitrate removal systems (e.g., ion exchange, reverse osmosis, electrodialysis) is a steady byproduct of concentrated brine, often referred to as a reject stream. Although some jurisdictions permit discharge of reject streams as industrial effluents, a growing number require controlled disposal because local wastewater treatment facilities may not be suitably equipped to treat water having total dissolved solids (TDS) exceeding a threshold.

Further, water recovery operations core to nitrate removal systems serve to concentrate all contaminants, not just nitrate. In some circumstances, even if a reject stream has a suitable TDS and/or a suitable nitrate level to otherwise be processed at a wastewater treatment facility as permitted industrial effluent, that stream may nevertheless have a concentration of another contaminant that exceeds a different threshold, disqualifying the reject stream from disposal as industrial effluent. In such circumstances, controlled disposal of brine is required.

In view of the foregoing, it may be appreciated that circumstances can require controlled handling and disposal of brine. However, as known to a person of skill in the art, controlled disposal of brine is expensive, may involve toxic or caustic material handling capability, and is mechanically and operationally complex.

Moreover, many conventional nitrate removal systems (such as reverse osmosis systems) exhibit low water recovery efficiency. For example, many performant utility scale reverse osmosis systems recover only up to seventy percent of water from an untreated volume. Because of this inefficiency, utility scale water treatment facilities with nitrate removal capability require an exceptionally large footprint in order to maintain required output volume. Large footprint facilities are not readily constructable or operable at all sites requiring denitrification of water sources.

Compounding all the foregoing issues with nitrate removal systems is agricultural runoff. Fertilizers used for agricultural purposes can contaminate otherwise uncontaminated groundwater or surface water sources, requiring even more denitrification capacity in even more locations.

In view of the foregoing, it may be appreciated that generally and broadly, conventional nitrate removal systems are (1) expensive to install and operate, (2) require significant space, power, and regular skilled maintenance, especially when operated at scale, (3) produce dangerous waste byproducts, and (4) often operate and scale inefficiently.

Nitrate reduction systems have been used as a substitute for or compliment to nitrate removal systems and blending techniques. Nitrate reduction systems leverage biological denitrification to destroy and/or otherwise remove nitrate in a water volume. Specifically, specialized heterotrophic bacteria are introduced to a treatment volume (often referred to as a biological reactor), along with a carbon source (an electron donor such as acetic acid), to facilitate biological conversion of nitrate into nitrogen gas, thereby reducing nitrate concentration without producing a reject stream.

Despite the significant advantage over nitrate removal systems of not producing a reject stream in need of disposal, conventional nitrate reduction systems have several disadvantages. A primary disadvantage is that conventional nitrate reduction systems typically require multiple stages of biological reactors, each of which produce a sludge of biological waste that settles and reduces available physical reaction volume and/or fouls downstream components or filters. Each biological reactor requires downtime so that an under-drain can be opened to separate and remove accumulated sludge. In addition, repopulation of bacteria may be required from time to time.

Conventional biological reactors used in nitrate removal systems can be categorized as fluidized bed or packed bed reactors. Fluidized bed constructions require mechanical agitation/stirring, such as with an overhead mixer, to distribute bacteria and carbon sources in suspension within each tank. In many cases, fluidized bed constructions may require significant downtime to clear dead biomass, as settlement takes time once agitation stops. In packed bed constructions, backwashing and/or forward washing may be required from time to time if differential pressure between input and output exceeds a threshold.

Further to the foregoing, biological denitrification systems require precise anoxic conditions to enable the bacteria to convert nitrate into nitrogen gas. More specifically, as known to a person of skill in the art, if dissolved oxygen (DO) of a water source exceeds a threshold, heterotrophic bacteria can obtain oxygen from DO, thereby significantly throttling or stopping denitrification entirely. In fluidized bed constructions, if agitation is required, anoxic conditions may be difficult to maintain, especially in small size reaction volumes within which environmental conditions regularly change (e.g., offline timing backwashing necessitating flow stoppage). More simply, the more moving parts within a fluid system, the more difficult it is to maintain anoxic conditions required to maintain biological denitrification.

Further to the foregoing, conventional nitrate reduction systems require pumping between biological reactors and/or other filters or holding tanks, which introduces additional failure points, mechanical complexities, and operator monitoring, each of which is associated with maintenance and operational costs.

In addition, conventional second stage/post filters associated with conventional biological reactors typically have a lower flow rate than the preceding biological reactors. In other words, required post filters are typically large size in comparison to the biological reactor. Apart from associated cost and space requirements, such large size post filters require frequent backwashing, which also requires the conventional biological denitrification system to be taken briefly offline (e.g., a period of 15-30 minutes may be typical). During this offline time, a separate backwash water source is drained and/or accessed, and a separate backwash system and pump is operated. All of these requirements are associated with additional operator time, maintenance costs, freshwater supplies, and the like.

Further, during backwash intervals, the conditions within the biological reactor change. Specifically, flow stops, fluidized bacteria may be allowed to settle, carbon sources may increase in concentration, temperature may change as a result of flow stopping, and so on. This inconsistent environment can stress the bacterial population, resulting in inconsistent denitrification output once the system is brought back online, which in turn often necessitates larger holding tanks. More simply, regularly changing the environment occupied by denitrifying bacteria reduces denitrification performance and stability.

In view of the foregoing, it may be appreciated that generally and broadly, conventional nitrate reduction systems are (1) expensive to install and operate, (2) require significant space, power, and regular skilled maintenance, especially when operated at scale, (3) and (3) often operate and scale inefficiently.

Embodiments described herein address these and other downsides of conventional nitrate reduction systems and nitrate removal systems by leveraging a fluidized bed biological reactor architecture that does not require pumping or mechanical agitation and that self-mixes to efficiently maintain output nitrate levels below EPA standard MCL. Further, architectures described herein have high tolerance to varying DO levels, and do not require careful maintenance of anoxic conditions. In addition, embodiments described herein operate at source pressure and thus exhibit high volume output. Finally, embodiments described herein occupy a small footprint and thus can be linearly scaled at substantially any site.

In particular, embodiments described herein relate to pressurized biological denitrification systems including at least one biological reaction volume configured for upflow feed of a water supply in need of denitrification.

As a result of this construction, source water pressure serves to agitate denitrifying bacteria within the reaction volume, ensuring that bacterial surface area (and thus reaction capacity of the reaction volume) is maximized and that doses of external carbon source material (e.g., typically an electron donor, such as acetic acid) are appropriately and quickly dissolved and distributed within the biological reactor. Further, upflow configuration of the reaction volume reduces settlement of nonreactive biomass (i.e., dead bacteria; often referred to as “sludge”) within the reaction volume, thereby increasing time between backwash or other maintenance downtime.

For embodiments described herein, a circulator/doser loop (also referred to as a recirculation loop) is coupled to and receives output of the reaction volume. The circulator/doser loop returns a portion of its output to the reaction volume and provides a portion of its output to one or more post filters. The circulator/doser loop includes a gas relief valve for venting nitrogen gas to atmosphere (or a capture and storage system), one or more sensor ports, one or more flow meters, one or more controllable circulator pumps, one or more carbon augmentation dosing ports, one or more phosphor augmentation dosing ports, and one or more pH control dosing ports. Dosing within the loop allows for additives to dissolve and/or perfuse more effectively without risking that a dose will not have time to dissolve or perfuse before being carried out as outflow. Further, conventional systems that does within the reaction volume itself often require time to distribute uniformly within the volume, often leading to gradients and inefficient denitrification.

Each of these dosing ports can be coupled to a respective electronically-controllable doser in turn operatively coupled to a controller, such as a programmable logic controller or other computing device. The controller is likewise operably coupled to a plurality of sensors configured to sample water within the circulator/doser loop via the sensor ports. Example sensors may probe for nitrate levels (or proxies therefor), pH, and the like. The controller can operate as a closed loop controller in which sensor inputs determine adjustments to doses of carbon, phosphorus, or an alkaline additive so as to maintain a target nitrate removal reduction within the reactor. Output of the circulator/doser loop is denitrified water that may contain a quantity of biological matter (e.g., living or dead bacteria).

Aeration and/or additive stages (e.g., chlorination, fluoridation, mineralization, as examples) can follow the circulator/doser loop. Doses of additive(s) can vary from site to site and/or may vary by local rules or regulations. In some cases, additives may not be required. Additives and/or aeration can be controlled by the controller or, in some cases, by another PLC or computing module. In many cases, aeration can serve as an oxidizing filter.

Output/outflow (pressurized) of the aeration and/or additive stages can be provided as input to one or more post filters configured with an appropriate bed depth of filter media (e.g., manganese dioxide ore). Other filleter media can include but may not be limited to: carbon; sand; anthracite; combinations thereof; ceramic media; or, more broadly, any granular media approved for potable or non-potable applications (e.g., by an organization such as the National Sanitation Foundation). In other cases, post filter media may be selected for suitability for stormwater treatment such as bone char, coconut shell media, membranes filters, and the like.

The post filters can be coupled to the aeration and/or additive stages in a downflow configuration, but this is not expressly required and may vary from embodiment to embodiment. In many constructions, although not expressly required, multiple post filters can be coupled in parallel, and taken offline for backwashing at staggered intervals. For example, if each post filter is backwashed once per twenty-four hours of service, a set of six post filters may be used. In this example, one filter may be disconnected and backwashed every four hours. As a result, in this construction, five post filters are in service at all times.

Output/outflow of the post filter(s) can be provided as a pressurized denitrified water output. In many cases, output of the post filter(s) can be sampled to assess turbidity (i.e., clarity) or other properties, such as chlorine level or another solute level. In some cases, if turbidity exceeds a threshold, process augmentations may be made automatically by the controller.

For example, a high turbidity measurement may signal a need to increase backwash frequency, a dose of filter aid (e.g., coagulating agent, polymers, diatomaceous earth, and the like), a need to enable additional post filter stages, or, in some cases, may indicate an overpopulation of denitrifying bacteria in one or more reaction volumes, signaling a need for augmentation of phosphorous or carbon doses in one or more circulator/doser loops.

As may be appreciated, the foregoing described architecture operates at source pressure, and does not require inter-stage pumping or repressurizing, significantly reducing mechanical complexity and operating costs. Further, as a result of upflow feeding of reaction volume(s), the source pressure itself drives agitation of bacterial suspension, improving reliability and consistency of biological denitrification. One or more controllers can monitor the denitrification process and augment dosing of carbon sources (e.g., acetic acid) and phosphor sources (phosphoric acid) to maintain a suitable bacterial population while additionally maintaining suitable pH (e.g., by dosing NaOH or another base appropriately).

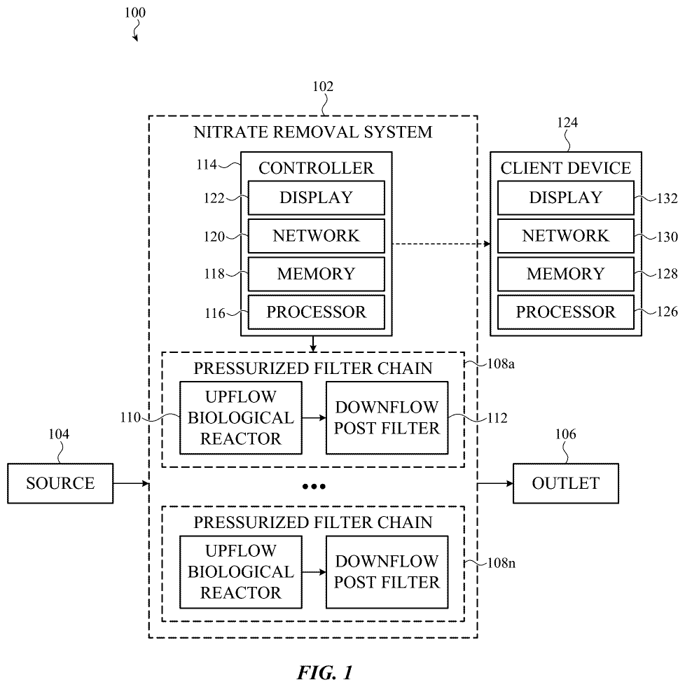

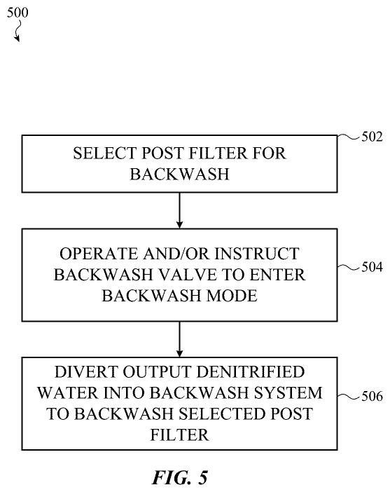

These foregoing and other embodiments are discussed below with reference to FIGS. 1-5. However, those skilled in the art will readily appreciate that the detailed description given herein with respect to these figures is for explanation only and should not be construed as limiting.

FIG. 1 depicts a system diagram of a modular denitrification system as described herein. The denitrification system 100 can be configured at and/or deployed to a number of suitable sites at which source water, whether ground water or surface water, contains undesirably high levels of nitrate, requiring reduction to a lower level referred to herein as a target nitrate level. In many cases, target nitrate levels may be below detectability (i.e., functionally no nitrated), or may be below EPA standard MCL for drinking water.

In other cases, target nitrate levels may be selected for a specific intended purpose, such as for agricultural irrigation, for reintroduction to surface water, for discharge as effluent input to a waste treatment facility, or the like. In other examples, a system as described herein can be operated as a prefilter to another conventional nitrate removal system. In these examples, a system as described herein can serve to improve water recovery efficiency and/or to reduce reject stream/brine volume output by the conventional nitrate removal system.

In view of the foregoing, generally and broadly, a person of skill in the art may appreciate that different nitrate levels can be targeted given different circumstances. For simplicity of description, the embodiments that follow contemplate a deployment in which the denitrification system 100 is configured to provide drinking water as output; this is merely one example denitrification purpose for which a system as described herein can be configured.

For simplicity of description, the embodiments that follow presume a groundwater source, but this is not required of all embodiments. In non-groundwater embodiments, an input pump may be required to establish appropriate pressure. As an example, a surface water source such as a storage reservoir may be at least partially denitrified by pumping through a system as described herein. In such examples, the system may be configured to discharge back into the storage reservoir.

As noted above, the denitrification system 100 can be configured to denitrify a ground water source, such as a well, to output water suitable for drinking. In this configuration, the denitrification system 100 may include two or more distinct denitrification water treatment chains, the denitrification treatment chains 102, operating in parallel and/or in a switch-over or fail-over configuration such that if one denitrification treatment chain fails, denitrification of water can continue uninterrupted. A person of skill in the art understands that many configurations are possible.

Generally and broadly, the denitrification treatment chains 102 receive input water from a water source, the source 104, and provide output at an outlet 106. In many constructions, head pressure at the source 104 is approximately equal to head pressure at the outlet 106. More specifically, for embodiments described herein, pressure drop from the source 104 to the outlet 106 may be negligible; inflow pressure and outflow pressure may be substantially similar.

As noted above, the source 104 is a source of untreated water having an undesirable nitrate concentration. The denitrification treatment chains 102 receive untreated water from the source 104 via appropriate plumbing that can be split among multiple paths to direct untreated water to one or more pressurized denitrification modules, such as described herein.

The denitrification treatment chains 102 can include multiple pressurized denitrification modules, each of which may be similarly configured. In other cases, different modules can be configured in different ways. Each stage of each chain can be described in respect of inflow and outflow. Inflow and outflow in many embodiments are at pressure, which may be substantially equal to head pressure of the source 104. However, for simplicity of description the embodiments that follow reference a configuration in which all modules are configured in the same manner, to scale output and/or to provide redundant capacity. In the illustrated embodiment, the denitrification treatment chains 102 includes n modules, two of which are labeled as the pressurized denitrification module 108a and the pressurized denitrification module 108n. As a result of this parallel architecture, the denitrification system 100 can operate without interruption, even when backwashing and/or servicing of one or more of the denitrification treatment chains 102 is required.

As noted above, the multiple pressurized denitrification modules can be configured in similar ways. For simplicity of description, the pressurized denitrification module 108a is described herein, and it may be appreciated that other modules make be configured to operate similarly.

The pressurized denitrification module 108a includes a biological reactor populated with one or more suitable heterotrophic bacterial strain(s), each of which is able to (presuming suitable conditions) convert nitrate (either directly or through two or more intermediate forms) into nitrogen gas. For embodiments described herein, the biological reactor can be configured for upflow, meaning that input pressurized water plumbed from the source 104 is coupled to the reactor in a manner such that water flows upward in relation to force of gravity. As illustrated in FIG. 1, the pressurized denitrification module 108a includes an upflow configured biological reactor 110.

As with other embodiments described herein, the upflow configured biological reactor 110 can be defined at least in part by a tank or other volume configured to retain, support, and hold a volume of water and a population of bacteria, fluidized or otherwise suspended within the water. The tank can be any suitable size and/or configured to hold any suitable volume of water. An example tank size may be ten thousand gallons, although other volumes both larger and smaller are possible and contemplated herein.

The tank of the upflow configured biological reactor 110 can have any suitable shape and/or cross-section. In many cases, as known to a person of skill in the art, a cylindrical volume may be preferred for both manufacturability and performance under pressure. For simplicity of description, the embodiments that follow reference a configuration in which the upflow configured biological reactor 110 includes a cylindrical tank, but this is merely one embodiment.

As noted above, the cylindrical tank of the upflow configured biological reactor 110 can be coupled to the source 104 in a manner that supports upflow within the tank. In some embodiments, the source 104 is coupled to an inlet positioned on a lower endcap of the cylindrical tank. In this configuration, untreated water supplied by the source 104 enters the tank generally along a central axis of the tank itself from which a radius of the cylindrical tank is defined.

In other cases, an inlet to the tank to which the source 104 is operably coupled or otherwise plumbed can be positioned along a sidewall of the tank, perpendicular to the central axis of the tank. In such constructions, the inlet is positioned within a lower portion of the tank (e.g., generally below a vertical centerline of the tank, as installed).

In still further examples, the inlet can be positioned within a lower portion of a sidewall of the tank, offset relative to a central axis of the tank such that untreated water supplied by the source 104 enters the tank generally tangent to sidewalls of the tank, thereby inducing and/or otherwise encouraging a vortex or other radial flow pattern within the tank. These foregoing examples are not exhaustive; the tank can be coupled to the source 104 in a number of suitable locations to facilitate upflow. In some cases, the source 104 can be coupled to multiple inlets of the same tank whereas in others, a single inlet may be suitable.

As noted above, the upflow configured biological reactor 110 is populated with a bacterial strain (or, in some cases, more than one strain) able to convert nitrate within the untreated water into nitrogen gas. The upflow configuration of the upflow configured biological reactor 110 serves to supply the upflow configured biological reactor 110 with nitrate rich water from the source 104, while also serving to agitate the bacteria therein into a more uniform distribution. More specifically, as a result of upflow configuration, mechanical agitation of the volume is not required.

In addition to bacteria, water undergoing treatment within the tank of the upflow configured biological reactor 110 can be doped with a carbon source such as acetic acid. In many cases, it may also be desirable to supply the bacterial population with a quantity of phosphorous; in such examples, the water within the tank can be doped with an appropriate quantity of phosphoric acid.

Dose concentrations (e.g., quantities of dissolved carbon source and, optionally, phosphorous) vary from embodiment to embodiment but, as may be appreciated by a person of skill in the art, do serve to regulate conditions facilitating or inhibiting bacterial activity within the tank of the upflow configured biological reactor 110. More generally, if either or both acetic acid or phosphoric acid concentration is too high or too low, bacteria within the volume may not be optimally productive and/or may become inviable. In other cases, bacteria may bloom and become too populous within the tank, and may pass to subsequent stages of the pressurized denitrification module 108a.

To prevent any biological matter, whether living or otherwise, from exiting the pressurized denitrification module 108a, following the upflow configured biological reactor 110 is a set of one or more post filters, one of which is identified as the downflow configured media filter 112. The post filters may be configured for downflow. In other cases, the post filters may be upflow configured; may constructions are possible.

The downflow configured media filter 112 can include a filter media configured to bind to and/or trap debris including slough or living bacteria that migrated out of the upflow configured biological reactor 110. As a result of this configuration, output of the downflow configured media filter 112 can be plumbed to the outlet 106.

As noted above, concentrations of carbon source, bacteria, phosphorous all inform denitrification performance. Increasing carbon may serve to promote bacterial growth, which in turn may increase denitrification, but may also cause fouling of the downflow configured media filter 112. Similarly, increasing phosphorous may change pH of the water undergoing treatment within the tank of the upflow configured biological reactor 110, which can create an environment unsuitable for the bacterial population. In these cases, denitrification efficiency may drop.

Further, as may be appreciated by a person of skill in the art, nitrate levels of the source 104 along with target nitrate levels for the output 106 further inform how much denitrification is required. This requirement in turn informs, directly or indirectly, how much bacterial activity is required to achieve the target denitrification at the output 106.

In view of the foregoing, the denitrification treatment chains 102 can be centrally managed and/or controlled by a central controller 114. The central controller 114 can be any suitable electronic device configured to interoperate with one or more electronically-controllable dosing modules and/or one or more sensors associated with one or more of the modules of the denitrification treatment chains 102.

For example, the central controller 114 can be communicably coupled to a nitrate sensor disposed within a sampling port interposing the source 104 and the pressurized denitrification module 108a. The central controller 114 can likewise be communicably coupled to a second nitrate sensor disposed within a sampling port interposing the upflow configured biological reactor 110 and the downflow configured media filter 112. These two nitrate sensors can be sampled by the central controller 114 on an interval or in another suitable manner to determine denitrification performance of the upflow configured biological reactor 110. More simply, the central controller 114 can be configured to compare nitrate concentration at the input of the upflow configured biological reactor 110 and nitrate concentration at the output of the upflow configured biological reactor 110 to determine real-time denitrification performance of the biological reactor.

In addition, the central controller 114 can be operably coupled to one or more electronically-controllable dosing modules, each configured to incrementally add one or more volumes of material into the upflow configured biological reactor 110. For example, a first electronically-controllable dosing module can be configured to add a volume of acetic acid in response to an instruction issued by the central controller 114. The system can also include a second electronically-controllable dosing module configured to add a volume of phosphoric acid in response to another instruction issued by the central controller 114. The electronically-controllable dosing modules can be configured to dose a particular volume specified by the instruction or may be configured to dose a particular fixed volume a variable number of times; many constructions and configurations are possible. Generally and broadly, the central controller 114 can be configured to issue instructions to one or more electronically-controllable dosing modules to increase dosing of a carbon source and/or a phosphorous source.

In many cases, the electronically-controllable dosing modules can be configured to dose a fixed quantity of material at a fixed interval. For example, a certain quantity of acetic acid is dosed by an electronically-controllable dosing module every 60 seconds, whereas a different quantity of phosphoric acid is dosed by another electronically-controllable dosing module every 60 minutes. These examples are not exhaustive; any suitable interval and/or volume of dose is possible. In some constructions, the central controller 114 may be configured to issue a command to change an interval and/or a volume dosed by a particular electronically-controllable dosing module. For example, in some constructions, the central controller 114 can be configured to issue a command in the form of a structured data object including two attributes, a volume and an interval. As an example, the structured data object can conform to a defined format such as XML or JSON. As an example, a structured data object transmitted by the central controller 114 to an electronically-controllable dosing module may conform to the JSON format. An example follows:

```
{
  “vol_ml” : 15,
  “dose_interval_s” : 300
}
```

In this example, the central controller 114 instructs the electronically-controllable dosing module to dose a particular material, such as acetic acid or phosphorous, at a volume of 15 ml every 300 seconds. As may be appreciated the frequency of doping and/or doping volume will be implementation specific.

In some cases, the central controller 114 can be configured to issue a temporary instruction, such as an instruction to increase dose volume for a period of 5 minutes. In other cases, an instruction can durably change configuration of the electronically-controllable dosing module such that until a next command is received.

The foregoing example is merely one configuration. It may be appreciated that in other constructions, a controller and electronically-controllable dosing module can be configured for serial communication or another communication protocol or standard. In other cases, the electronically-controllable dosing module may not include control electronics at all-in such examples, the central controller 114 can be configured to control a relay or contactor that causes an electronic element, actuator, or the like within the electronically-controllable dosing module to actuate and dose a particular volume into the upflow configured biological reactor 110.

In view of the foregoing it may be appreciated that many constructions are possible, but that generally and broadly a controller as described herein is typically configured to electronically control doses of one or more materials within the upflow configured biological reactor 110.

As noted above, increasing carbon and/or phosphorous by operation of the central controller 114 within the upflow configured biological reactor 110 can serve to increase bacterial productivity and/or growth. As such, in response to the central controller 114 determining that real-time denitrification within the upflow configured biological reactor 110 exceeds a target level, the central controller 114 can be configured to reduce doping volume, frequency, or both of acetic acid to slow bacterial growth and propagation. This operation of the central controller 114 can serve to prevent premature fouling of the downflow configured media filter 112. In other cases, the central controller 114 may determine that increasing or decreasing dose or frequency of phosphoric acid may be appropriate in order to regulate the bacterial population.

In yet other examples, the central controller 114 can be additionally coupled to one or more pH sensors configured to measure pH of water exiting the upflow configured biological reactor 110. In these examples, should pH drop, the central controller 114 can be configured to instruct another electronically-controllable dosing module to add lye (NaOH, caustic soda) or another alkaline substance to the upflow configured biological reactor 110. In this manner, the central controller 114 can be configured to ensure stable pH of the upflow configured biological reactor 110.

In yet further embodiments, the central controller 114 can be configured to operate an aeration/oxidizing module and/or a chlorine doping module. In these examples, the central controller 114 can be coupled to additional sensors disposed after output of the downflow configured media filter 112 to determine chlorine levels. If levels drop below a target level, the central controller 114 can increase chlorine dosing appropriately.

In yet other examples, concentrations of other additives can be controlled by the central controller 114. Examples include fluoridation, dissolved minerals for taste, carbonation, and so on.

In yet other examples, the central controller 114 can be configured to sense turbidity of water output from the downflow configured media filter 112. Upon determining that turbidity exceeds a threshold, the central controller 114 can schedule and/or instruct an automated backwash operation of the downflow configured media filter 112.

The central controller 114 can be implemented in a number of suitable ways. In some cases, the central controller 114 can be a programmable logic controller. In others, the controller may be a more general purpose computing resource configured to instantiate one or more instances of control software each of which may be configured to interface with one or more electronically-controllable doping modules as described herein or with one or more sensors as described herein. In these examples, the central controller 114 can include a processor 116 and a memory 118. The memory 118 can be configured to store one or more executable instructions that, when accessed by the processor 116 cause to be instantiated at least partially within the memory 118 an instance of software configured to perform, coordinate, or monitor one or more tasks associated with operation of the denitrification system 100. In some cases, although not required of all embodiments, the central controller 114 can include a network communications module 120 and in some cases a display 122. The network communications module 120 can enable remote command and control and monitoring of the central controller 114, and the display 122 can be configured to render a graphical user interface conveying information in respect of operation and/or state of the denitrification system 100.

As noted above, the network communications module 120 can support remote access to the central controller 114. For example, the central controller 114 can be, in some embodiments, communicably coupled to a client device 124. The client device 124 can be any suitable portable or stationary electronic device. Examples include cellular phones, desktop computers, laptop computers, industrial control appliances, programmable logic controllers, and so on.

The client device 124 can include a processor 126, a memory 128, a network communications module 130 and/or a display 132. These components can cooperate to instantiate an instance of frontend software configured to provide an interface for an operator of the device to issue commands to the central controller 114 to change one or more operational parameters of the denitrification system 100.

These foregoing embodiments depicted in FIG. 1 and the various alternatives thereof and variations thereto are presented, generally, for purposes of explanation, and to facilitate an understanding of various configurations and constructions of a water denitrification system, such as described herein. However, it will be apparent to one skilled in the art that some of the specific details presented herein may not be required in order to practice a particular described embodiment, or an equivalent thereof.

Thus, it is understood that the foregoing and following descriptions of specific embodiments are presented for the limited purposes of illustration and description. These descriptions are not targeted to be exhaustive or to limit the disclosure to the precise forms recited herein. To the contrary, it will be apparent to one of ordinary skill in the art that many modifications and variations are possible in view of the above teachings.

For example, in many embodiments, dosing of the upflow configured biological reactor 110 can be performed within a recirculation loop tapping output/outflow (pressurized) of the upflow configured biological reactor 110, dosing the tapped output according to instructions of the central controller 114, returning the dosed water back to the upflow configured biological reactor 110, thereby self-blending already denitrified water with the nitrate-rich water within the upflow configured biological reactor 110. This recirculation technique can serve to further assist with agitation of the bacterial suspension within the upflow configured biological reactor 110.

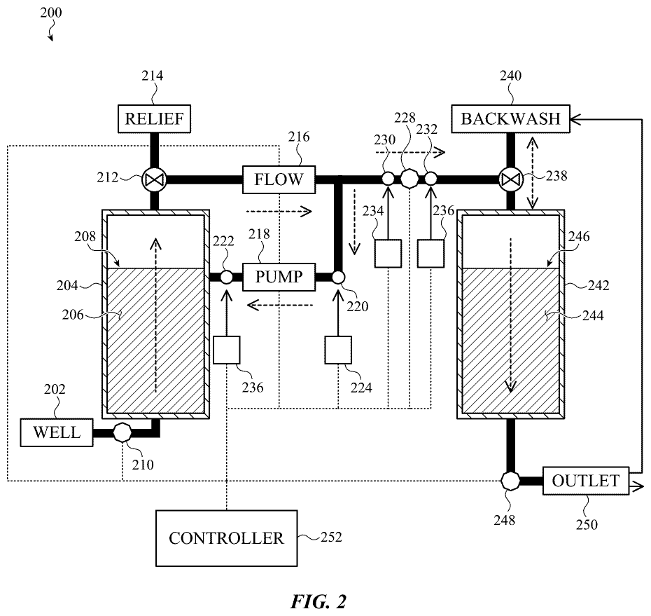

FIG. 2 depicts a simplified schematic diagram of a pressurized denitrification system as described herein. The pressurized denitrification module 200 can be similar to the pressurized denitrification module 108a or the pressurized denitrification module 108n of FIG. 1, although this may not be required of all embodiments.

In the illustrated schematic, the pressurized denitrification module 200 receives nitrate rich water from a source 202, which may be a groundwater source such as a well. The source 202 provides input nitrate-rich water to an upflow configured biological reaction volume 204.

The upflow configured biological reaction volume 204 can be any suitable volume configured to retain, support, and enclose water under pressure. The upflow configured biological reaction volume 204 can be formed form metal or another suitable material and can have substantially any suitable shape.

As with other embodiments described herein, the upflow configured biological reaction volume 204 is coupled to the source 202 in a manner supporting upflow through the upflow configured biological reaction volume 204. The source 202 may be coupled to a bottom endcap of the upflow configured biological reaction volume 204, a lower sidewall portion of the upflow configured biological reaction volume 204, or in another suitable location.

The upflow configured biological reaction volume 204 also serves to enclose, agitate, and distribute through the nitrate-rich water provided from the source a biological suspension 206. The biological suspension 206, as described above, includes one or more strains of bacteria configured to convert, either directly or indirectly, nitrate into nitrogen gas and/or other non-nitrate byproducts (e.g., water, OH, H₂O and so on; a person of skill in the art appreciates that denitrification processes/redox reactions vary as may byproducts thereof).

Quantity of bacteria varies from embodiment to embodiment. An excess of bacteria can cause fouling of post filters, whereas an underpopulation of bacteria may not achieve target denitrification performance. As known to a person of skill in the art, a biological reactor may in some cases be classified by a depth or height of the biological suspension, relative to the upflow configured biological reaction volume 204. The figure illustrates a biological suspension depth 208, but it may be appreciated that the illustrated schematic is not drawn to scale.

As a result of the upflow configuration of the upflow configured biological reaction volume 204, biological suspension 206 is agitated and fluidized by head pressure of the source 202 itself, thereby increasing the biological surface area of the biological suspension 206 in contact with nitrate-rich water. More simply, agitation by upflow configuration increases bacterial activity, and increases rate of denitrification.

Once water is denitrified by the biological suspension 206, water can exit the upflow configured biological reaction volume 204 through a port or outlet at an upper portion of the upflow configured biological reaction volume 204, such as a top endcap thereof. In addition, the pressurized denitrification module 200 can include a vent port, which may be a check valve or pressure bleed valve, for venting nitrogen gas to atmosphere or into a storage tank. Specifically, the pressurized denitrification module 200 can include the pressure venting valve 212 including at least a nitrogen gas outlet 214.

Water output/outflow (pressurized) of the upflow configured biological reaction volume 204 can enter a recirculation and dosing loop. The recirculation and dosing loop can be configured ensure that the upflow configured biological reaction volume 204 maintains suitable bacterial conditions.

The recirculation and dosing loop includes a flow meter 216 configured to measure flow of water output from the upflow configured biological reaction volume 204. The flow meter 216 can in turn be coupled, either directly or indirectly, to a recirculation pump 218 (e.g., a variable frequency drive pump or a variable speed drive pump; many configurations are possible and vary by pump type). Co-operation of the flow meter 216 and the recirculation pump 218 can ensure continued operation of the dosing loop and, in turn, suitable dosing of the upflow configured biological reaction volume 204 with appropriate material.

The recirculation and dosing loop also includes one or more dosing ports. Specifically, the recirculation and dosing loop includes a dosing port 220 and a dosing port 222.

The dosing port 220 can be coupled to and/or associated with an electronically-controllable doser 224 configured to inject a suitable quantity of an electron donor material and carbon source, such as acetic acid. Other suitable examples include methanol, ethanol, acetate, or similar. The electronically-controllable doser 224 can include one or more pumps, valves, augers, or any other suitable injection system or chemical feed mechanism. Examples include proportional injectors, metering pumps, and the like. A person of skill in the art may readily appreciate that the electronically-controllable doser 224 can be configured in a number of suitable ways.

In many embodiments, the electronically-controllable doser 224 can be further configured to dose a phosphorus source such as phosphoric acid. In this manner, the electronically-controllable doser 224 can be configured to dose one or more materials into the recirculation and dosing loop to be injected back into the upflow configured biological reaction volume 204 by operation of head pressure of the source 202 assisted by operation of the recirculation pump 218.

The dosing port 222 can be couple to and/or associated with an electronically-controllable doser 226 configured to inject a suitable quantity of an alkaline material, such as lye (caustic soda, NaOH). The electronically-controllable doser 226 can be operated periodically and/or at a particular interval to maintain a suitably neutral pH within the upflow configured biological reaction volume 204.

In view of the foregoing, it may be appreciated that the recirculation and dosing loop serves to maintain suitable conditions for the biological suspension 206 within the upflow configured biological reaction volume 204, thereby supporting a consistent, predictable, and volume-efficient denitrification process.

Output/outflow of the recirculation and dosing loop can also be directed to one or more post filters before being provided as denitrified water as output.

Interposing the recirculation and dosing loop and the post filters may be one or more sensing ports, injection ports, and/or additional dosing ports. For example, the pressurized denitrification module 200 can also include a secondary nitrate concentration sensing port 228, an aeration/oxidizing port 230, and an additive dosing port 232. The aeration/oxidizing port 230 can be coupled to an electronically-controllable aerator 234 configured to aerate denitrified water for taste or specification. The additive dosing port 232 can be associated with an electronically-controllable additive doser 236 configured to, in some cases, inject doses of fluoride or chlorine. In other cases, other additives or disinfectants can be used.

Following optional additional sensing ports, injection ports, and/or additional dosing ports may be a valve that controls whether a post filter is in backwash mode or in filtering mode. In a backwash mode, the backwash mode valve 238 blocks water from the recirculation and dosing loop from entering subsequent filters, instead coupling to a backwash system 240.

Alternatively, in a filtering mode, the backwash mode valve 238 directs denitrified and/or additive-dosed water into a post filter, identified in the figure as the downflow configured media filter volume 242. As with the upflow configured biological reaction volume 204, the downflow configured media filter volume 242 includes a filter media 244 disposed to a filter media depth 246. An example material that may be used for the filter media 244 can be manganese dioxide. Other filter media can include but may not be limited to: carbon; sand; anthracite; combinations thereof; ceramic media; or, more broadly, any granular media approved for potable or non-potable applications (e.g., by an organization such as the National Sanitation Foundation). In other cases, post filter media may be selected for suitability for stormwater treatment such as bone char, coconut shell media, membranes filters, and the like.

In other cases, activated carbon may be used although this may not be preferred in all cases, as it may remove and/or bond to certain additives such as chlorine.

As denitrified water passes through the downflow configured media filter volume 242, any bacteria that flowed through the pressurized denitrification module 200 can be arrested by the filter media 244. More generally, the filter media 244 can be configured to arrest any particles of any desired or target particle size. In many cases, the particle size arrested by the filter media 244 can be selected to arrest particles at least a size of the denitrifying bacteria; in other cases, the arrested particle size can be selected based on a different substance or substances. In some cases, the filter media 244 can include multiple different particles or filter substances.

As a result of the operation of the filter media 244 (however configured), denitrified, aerated, and additive-doped water can be provided as output from the downflow configured media filter volume 242.

The pressurized denitrification module 200 can include additional sensors, such as the output sensor 248, to monitor output of the downflow configured media filter volume 242, such as a chlorine sensor and/or a turbidity (e.g., clarity) sensor. In response to detecting that chlorine is too low, the electronically-controllable additive doser 236 can be instructed to increase chlorine doping. In response to detecting the chlorine is too high, the electronically-controllable additive doser 236 can be instructed to decrease chlorine doping.

Similarly, in response to determining that turbidity is too high, polymer filter assist may be added to the downflow configured media filter volume 242. In other cases, if turbidity is too high, a backwash cycle may be instructed for the downflow configured media filter volume 242. During a backwash cycle, the backwash mode valve 238 can be actuated into a backwash mode, and the backwash system 240 can be activated to backwash the downflow configured media filter volume 242.

In this manner, the pressurized denitrification module 200 can receive nitrate-rich water as input at the source 202 and provide output of denitrified water at an outlet 250.

In many embodiments described herein, the backwash system 240 can be operably coupled to the output 250 such that denitrified water can be used to backwash the downflow configured media filter volume 242. In particular, in many embodiments, as noted above, the downflow configured media filter volume 242 can be a member of a set of media filters, such as a group of five individual media filters.

In this configuration, each respective filter may be physically smaller than conventional post filters, thereby requiring less time and water volume to backwash. In addition, backwashing can take place for a single filter at a time while all other filters continue to operate to provide denitrified and filtered water as output via the outlet 250.

As an example, if the source 202 provides influent water at a rate of 1000 gallons per minute (gpm), the pressurized denitrification module 200 may be configured to provide output from the outlet 250 at roughly 1000 gpm. In some constructions five post filters may be used, selected for a filter loading rate that can accommodate 250 gpm, which supports operational modes of all five filters working simultaneously (e.g., 200 gpm per filter) in addition to operational modes of four filters working simultaneously, with one filter being backwashed. In a backwash mode operation, four filters may experience a temporary increased loading rate while a selected post filter is backwashed.

In this example, the backwashed filter may consume 250 gpm of the output capacity of the pressurized denitrification module 200 for a backwash period, which may be 5 minutes or less in some embodiments, 10 minutes or less in other embodiments, or any other suitable time. In this example, output of the pressurized denitrification module 200 may drop by 250 gpm (e.g., to 750 gpm) for a five minute period while backwashing takes place. In this manner, the pressurized denitrification module 200 can ensure that conditions in the upflow configured biological reaction volume 204 remain constant during backwashing, establishing and continuing a consistent environment.

As noted above, in many embodiments, the pressurized denitrification module 200 can be automated by operation of a central controller, such as the central controller 252. The central controller 252 may be a programmable logic controller or computing resource or device suitably configured to communicably couple to the electronically-controllable doser 226, the electronically-controllable doser 224, the recirculation pump 218, the flow meter 216, the pressure venting valve 212, the electronically-controllable aerator 234, the input nitrate concentration sensing port 210, the electronically-controllable aerator 234, the electronically-controllable additive doser 236, the secondary nitrate concentration sensing port 228, the output sensor 248, the backwash mode valve 238, the backwash system 240, and so on.

More simply, the central controller 252 can be configured to augment dosing of carbon sources, alkaline additives, and phosphorous sources to maintain suitable conditions for the biological suspension 206. In response to detecting higher than target nitrate at the secondary nitrate concentration sensing port 228, the central controller 252 can increase carbon dosing. In response to lower than target nitrate at the secondary nitrate concentration sensing port 228, the central controller 252 may increase the rate at which backwashing is scheduled for the downflow configured media filter volume 242. In addition, a person of skill in the art may appreciate that the central controller 252 can leverage differential sensing at the nitrate concentration sensing port 228 and the input nitrate concentration sensing port 210 to determine by proxy oxygenation of influent water. More specifically, at steady-state, bacteria of the biological suspension 206 may first deoxygenate influent water, reducing DO before consuming oxygen from dissolved nitrate. The differential sensing of the two nitrate levels, compared against a theoretical denitrification output based on the biological suspension 206 and current levels of carbon dosing can be used to approximate DO of influent water.

More generally, the central controller 252 can determine, based on carbon dosing rates and bacterial population, how much denitrification effect should be expected from an anoxic condition water source. In non-anoxic conditions, denitrification capacity will drop as some bacteria will obtain oxygen from DO. More simply, anoxic nitrified influent water will require less bacteria and less carbon to denitrify than non anoxic influent water. By comparing predicted denitrification capacity given anoxic conditions to actual denitrification performance, the central controller 252 can determine and/or approximate DO within the influent water.

Importantly, as may be appreciated, the pressurized denitrification module 200 does not require anoxic conditions-the feedback loop managed by the central controller 252 serves to facilitate dosing of carbon to a level suitable to grow the bacterial population to a level suitable to consume DO in addition to denitrification.

In response to determining, via the output sensor 248, that chlorine levels are off-specification, the central controller 252 can instruct the electronically-controllable additive doser 236 to inject additional chlorine at the additive dosing port 232. In response to determining that turbidity is too high via output from the output sensor 248, the central controller 252 can schedule backwashing of the downflow configured media filter volume 242 sooner than otherwise scheduled (as sloughing/dead bacteria is impeding flow within the downflow configured media filter volume 242).

In some cases, the central controller 252 can be additionally coupled to one or more pressure sensors throughout the pressurized denitrification module 200. For example, the central controller 252 can be operably coupled to a pressure sensor at the input of the downflow configured media filter volume 242 and a second pressure sensor at the output of the downflow configured media filter volume 242. As a result of this configuration, the central controller 252 can obtain a differential pressure measurement that can serve as a signal for backwashing of the downflow configured media filter volume 242. More simply, the greater differential pressure (i.e., the more pressure drops within the downflow configured media filter volume 242), the more “clogged” the filter media 244 may be with bacterial slough, indicating a need for backwashing.

In this manner, the central controller 252 autonomously controls operation of the pressurized denitrification module 200 so that target nitrate levels at the outlet 250 stay consistent.

These foregoing embodiments depicted in FIG. 2 and the various alternatives thereof and variations thereto are presented, generally, for purposes of explanation, and to facilitate an understanding of various configurations and constructions of a water denitrification system, such as described herein. However, it will be apparent to one skilled in the art that some of the specific details presented herein may not be required in order to practice a particular described embodiment, or an equivalent thereof.

Thus, it is understood that the foregoing and following descriptions of specific embodiments are presented for the limited purposes of illustration and description. These descriptions are not targeted to be exhaustive or to limit the disclosure to the precise forms recited herein. To the contrary, it will be apparent to one of ordinary skill in the art that many modifications and variations are possible in view of the above teachings.

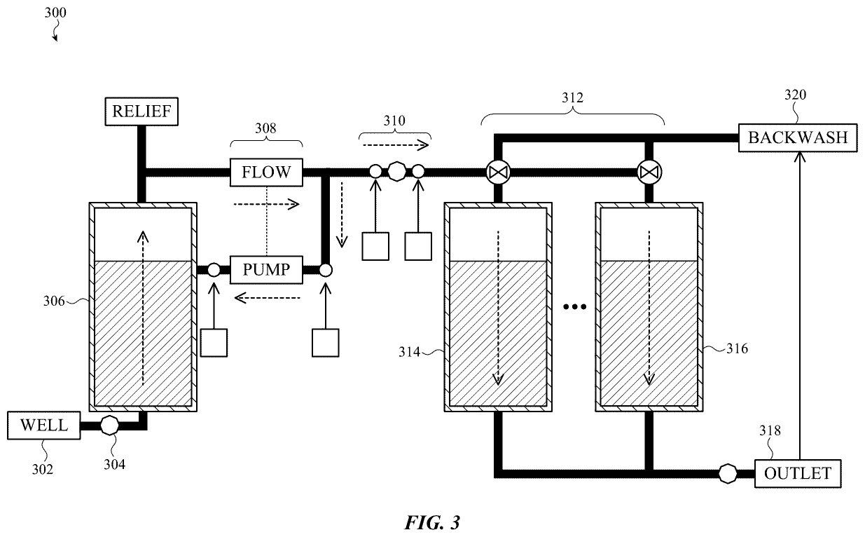

For example, in many embodiments, multiple post filters may be coupled to a single reactor to increase system processing volume. FIG. 3 depicts a simplified schematic diagram of a pressurized modular denitrification system as described herein.

The pressurized denitrification module 300 receives nitrate-rich water from a source 302, which may be sensed by an input nitrate sensor 304. Thereafter, the nitrate-rich water can be provided as input to an upflow configured biological reactor 306, such as described herein. Following the upflow configured biological reactor 306 may be a recirculation and dosing loop 308, which serves as noted above to maintain suitable conditions for the bacterial suspension within the upflow configured biological reactor 306. Following the recirculation and dosing loop 308 is an additive doser stage 310 which can be configured to verify nitrate levels and to add one or more additives, such as chlorine or fluoride. In other cases, the additive doser stage 310 also serves to aerate.

The recirculation and dosing loop 308 serves to inject carbon sources and other additives into partially denitrified influent water in a volume separate from the upflow configured biological reactor 306 itself, thereby mitigating clogging of any underdrains or distribution piping feeding the upflow configured biological reactor 306 itself. In this manner, the recirculation and dosing loop 308 serves a self-mixing or self-blending function.

Following the additive doser stage 310 can be a post-biological filter array 312, including a first post filter 314 and a second post filter 316, arranged in parallel. Each of the post filters can be associated with a respective one backwash mode valve and, likewise, each can be coupled to the outlet 318. As a result of this parallel construction, regular backwashing by a backwash system 320 can be performed in a staggered manner such that the second post filter 316 is backwashed when the first post filter 314 is operated in a filtering mode and vice versa. In other constructions, more than two post filters can be used. In some embodiments 3, 4, 5, 10, 20, 50 or 100 post filters may be coupled to the same biological reactor. In some cases, each post filter may be smaller or larger in volume than the associated biological reactor. In some embodiments, the post filters can include different filter media and/or may be configured to filter different dissolved solids from denitrified water. Many configurations are possible.

These foregoing embodiments depicted in FIGS. 2-3 and the various alternatives thereof and variations thereto are presented, generally, for purposes of explanation, and to facilitate an understanding of various configurations and constructions of a water denitrification system, such as described herein. However, it will be apparent to one skilled in the art that some of the specific details presented herein may not be required in order to practice a particular described embodiment, or an equivalent thereof.

Thus, it is understood that the foregoing and following descriptions of specific embodiments are presented for the limited purposes of illustration and description. These descriptions are not targeted to be exhaustive or to limit the disclosure to the precise forms recited herein. To the contrary, it will be apparent to one of ordinary skill in the art that many modifications and variations are possible in view of the above teachings.

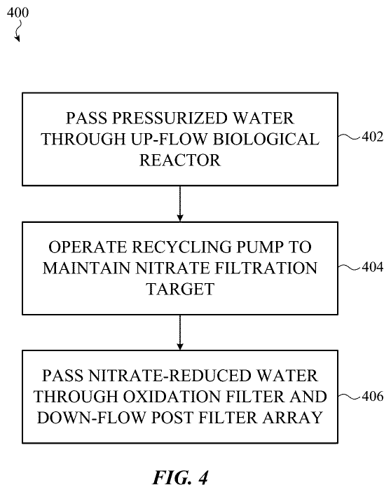

For example, it may be appreciated that many denitrification systems can be constructed to execute and/or perform methods described herein. For example, FIG. 4 depicts a flow chart corresponding to example operations of a method of denitrification, as described herein.

The method 400 can be performed by many systems and architectures. In many cases, the method 400 is performed at least in part by a denitrification system as described above in reference to FIGS. 1-3.

The method 400 includes operation 402 at which pressurized water (e.g., water from a source exhibiting head pressure, such as a well groundwater source), is received through an upflow configured biological reactor. At operation 402, a recirculation and doping loop is operated to maintain conditions that facilitate target nitrate reduction. Finally, at operation 404, nitrate-reduced water can be passed through one or more oxidation filters (e.g., aeration) and through one or more post filters to remove oxidized compounds and bacterial slough. Water output from the post filters can be provided as potable utility water or for another purpose.

As used herein, the phrase “at least one of” preceding a series of items, with the term “and” or “or” to separate any of the items, modifies the list as a whole, rather than each member of the list. The phrase “at least one of” does not require selection of at least one of each item listed; rather, the phrase allows a meaning that includes at a minimum one of any of the items, and/or at a minimum one of any combination of the items, and/or at a minimum one of each of the items. By way of example, the phrases “at least one of A, B, and C” or “at least one of A, B, or C” each refer to only A, only B, or only C; any combination of A, B, and C; and/or one or more of each of A, B, and C. Similarly, it may be appreciated that an order of elements presented for a conjunctive or disjunctive list provided herein should not be construed as limiting the disclosure to only that order provided.

One may appreciate that although many embodiments are disclosed above, that the operations and steps presented with respect to methods and techniques described herein are meant as exemplary and accordingly are not exhaustive. One may further appreciate that alternate step order or fewer or additional operations may be required or desired for particular embodiments.

Although the disclosure above is described in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the some embodiments of the invention, whether or not such embodiments are described and whether or not such features are presented as being a part of a described embodiment. Thus, the breadth and scope of the present invention should not be limited by any of the above-described exemplary embodiments but is instead defined by the claims herein presented.

What is claimed is:

1. A water treatment system for denitrification of groundwater, comprising:
an inlet coupled to a groundwater source;
an upflow configured reaction volume comprising:
an upper portion; and
a lower portion coupled to the inlet;
a population of heterotrophic bacteria within the upflow configured reaction volume;
a recirculation and dosing loop coupled to the upper portion of the upflow configured reaction volume and configured to recirculate at least a portion of water output from the upper portion of the upflow configured reaction volume back into the upflow configured reaction volume, the recirculation and dosing loop comprising an electronically-controllable additive doser configured to dose water within the recirculation and dosing loop with a carbon source;
a post filter coupled to the recirculation and dosing loop, configured for downflow, and comprising a filter media configured to arrest any heterotrophic bacteria of the population of heterotrophic bacteria that enter the post filter; and
an output port coupled to an output of the post filter.

2. The water treatment system of claim 1, wherein the post filter is a member of a set of post filters coupled in parallel to the recirculation and dosing loop and coupled in parallel to the output port.

3. The water treatment system of claim 1, wherein the heterotrophic bacteria are denitrifying bacteria.

4. The water treatment system of claim 1, wherein the population of heterotrophic bacteria is agitated and fluidized by head pressure of the water source.

5. The water treatment system of claim 1, wherein the electronically-controllable additive doser is coupled to a controller configured to adjust dosing of the carbon source based, at least in part, on a nitrate measurement sampled after the post filter.

6. The water treatment system of claim 1, wherein the carbon source is acetic acid.

7. The water treatment system of claim 1, wherein:
the electronically-controllable additive doser is a first electronically-controllable additive doser; and
the recirculation and dosing loop comprises a second electronically-controllable additive doser configured to dose water within the recirculation and dosing loop with an alkaline substance.

8. The water treatment system of claim 7, wherein the alkaline substance comprises lye.

9. The water treatment system of claim 7, comprising:
a controller configured to:
adjust dosing of the carbon source based, at least in part, on a nitrate measurement sampled after the post filter; and
adjust dosing of the alkaline substance based, at least in part, on the nitrate measurement sampled after the post filter.

10. The water treatment system of claim 1, wherein the filter media comprises manganese dioxide ore.

11. A water treatment system for denitrification of groundwater, comprising:
an inlet coupled to a pressurized water source;
a reaction volume comprising a population of denitrifying bacteria, the reaction volume coupled to the inlet and configured for upflow operation;
a recirculation loop coupled to the reaction volume and configured to recirculate a quantity of water output from the reaction volume back into reaction volume, the recirculation loop comprising an additive doser configured to dose water within the recirculation loop with an additive;
a post filter group comprising at least two post filters each of which:
is coupled to the recirculation loop;
is configured for downflow; and
comprises a filter media configured to arrest particles that enter the post filter; and
an output port coupled to an output of the post filter group.

12. The water treatment system of claim 11, comprising a controller configured to instruct the additive doser to dose the additive.

13. The water treatment system of claim 12, wherein the controller is configured to instruct the additive doser to adjust a schedule of dosing of the carbon source.

14. The water treatment system of claim 12, wherein the controller is configured to instruct the additive doser to adjust a volume of dosing of the carbon source.

15. The water treatment system of claim 12, wherein:
the controller is configured to select a post filter from the post filter group for backwashing; and
in response, initiating backwashing of the selected post filter by
instructing a backwash valve associated with the selected post filter to enter a backwash mode; and
diverting at least a portion of water directed from the post filter group to the output port to the selected post filter to backwash the post filter.

16. The water treatment system of claim 11, wherein the additive comprises one of:
a carbon source;
a phosphorous source; or
an alkaline substance.

17. A method of denitrifying groundwater, the method comprising:
receiving pressurized groundwater from a groundwater source;
providing the pressurized groundwater to a reaction volume so as to facilitate upflow within the reaction volume, the reaction volume comprising a population of denitrifying bacteria;
recirculating at least a portion of pressurized outflow of the reaction volume to a recirculation and dosing loop;
dosing water within the recirculation and dosing loop with at least one additive to support the population of denitrifying bacteria;
filtering pressurized outflow of the recirculation and dosing loop through a group of particle filters, each particle filter comprising a filter media and configured for downflow operation; and
providing pressurized outflow of the group of particle filters as potable water output.

18. The method of claim 17, comprising:
selecting a first particle filter from the group of particle filters for backwashing; and
backwashing the first particle filter with outflow of at least two of the remaining particle filters.

19. The method of claim 17, wherein the additive comprises phosphoric acid or acetic acid.

20. The method of claim 17, comprising aerating the pressurized outflow of the recirculation and dosing loop.
